(19) United States
(12) Patent Application Publication
(10) Pub. No.: US 2006/0077038 A1
(43) Pub. Date: Apr. 13, 2006

(54) Storage systems and methods

(76) Inventors: Steven P. Hopkins, Falconer, NY (US); Mark R. Harms, Kennedy, NY (US); Anthony A. Marchini, State College, PA (US)

Correspondence Address: KIRKPATRICK & LOCKHART NICHOLSON GRAHAM LLP, 535 SMITHFIELD STREET, PITTSBURGH, PA, 15222, US

(21) Appl. No.: 11/240,845

(22) Filed: Sep. 30, 2005

Related U.S. Application Data
(60) Provisional application No. 60/614,684, filed on Sep. 30, 2004.

(51) Int. Cl. B60R 25/00; H04L 9/32

(52) U.S. Cl. 340/5.73; 340/5.9; 340/5.22

(57) ABSTRACT

A method for securing materials in a normally locked compartment of a locker unit. The method includes associating an access code with the compartment and opening a door of the compartment upon entry of the access code by a patron. The method also includes dissociating the access code with the compartment when the patron desires to relinquish the compartment.

### CROSS REFERENCE TO RELATED APPLICATION

The present application claims priority to U.S. Provisional Application No. 60/614,684 filed Sep. 30, 2004.

### BACKGROUND

Storage systems are often placed in areas where patrons can store articles and retrieve them at a later time, or where articles are to be distributed to patrons. Such systems often work by giving a patron an assigned storage compartment, or locker, along with a key or an access code that will open a door on the assigned compartment. The patron can then access the compartment to store or retrieve articles at will. Such systems often do not allow the patrons to have control over events such as, for example, when a compartment is to be abandoned. Instead, such systems retain control over access and do not allow for patron access flexibility.

### SUMMARY

In one embodiment, the present invention is directed to a method for securing materials in a normally locked compartment of a locker unit. The method includes associating an access code with the compartment and opening a door of the compartment upon entry of the access code by a patron. The method also includes dissociating the access code with the compartment when the patron desires to relinquish the compartment.

In one embodiment, the present invention is directed to a locker system. The locker system includes a plurality of compartments, each compartment having a door in a normally locked position, and an electrical box assembly having a computer, the computer configured to:
associate an access code with the compartment;
effectuate the opening of a door of the compartment upon entry of the access code by a patron; and
dissociate the access code with the compartment when the patron desires to relinquish the compartment

In one embodiment, the present invention is directed to an apparatus. The apparatus includes means for associating an access code with a normally locked compartment of a locker unit and means for opening a door of the compartment upon entry of the access code by a patron. The apparatus also includes means for dissociating the access code with the compartment when the patron desires to relinquish the compartment.

In one embodiment, the present invention is directed to a computer readable medium having stored thereon instructions which, when executed by a processor, cause the processor to:
associate an access code with a normally locked compartment of a locker unit;
effect a door of the compartment to be opened upon entry of the access code by a patron; and
dissociate the access code with the compartment when the patron desires to relinquish the compartment

### DESCRIPTION OF THE DRAWINGS

FIG. 1 illustrates a locker system according to various embodiments of the present invention;

FIG. 2 illustrates an electrical box assembly according to various embodiments of the present invention;

FIG. 3 is a flow chart for a normal mode procedure according to various embodiments of the present invention;

FIG. 4 is a flow chart for a management mode procedure according to various embodiments of the present invention; and

FIGS. 5-10 are flow charts for various management routines according to various embodiments of the present invention.

### DETAILED DESCRIPTION

Various embodiments of the present invention are directed to storage systems, such as locker systems, which can be used as, for example, distribution or storage systems. Various embodiments of the present invention may be used when, for example, there is a large patron population or there is a need for short-term storage with high turnover. In various embodiments, patrons specify their own access code (i.e., access password) and the patron can then reserve a compartment and retrieve articles stored therein. In various embodiments, patrons may access the reserved compartment once when articles are stored therein and once when the articles are retrieved. In such embodiments, the patron is no longer granted access to the compartment upon retrieval of the articles and the assigned access code is removed from the system unless the patron specifies otherwise.

FIG. 1 illustrates an embodiment of a locker system 10 according to the present invention. In this embodiment, the locker system 10 includes one or more cabinets 100 for securing articles. In various embodiments, the cabinet 100 may be constructed from high-impact polycarbonate, stainless steel, aluminum, and/or plastic to withstand the challenge of elements from extreme heat to frigid cold.

Each cabinet 100 includes a plurality of doors 101 associated with corresponding compartments into which articles may be placed and/or from which articles may be retrieved. In various embodiments, the doors 101 are normally in a locked condition. As depicted, the cabinet 100 includes fifty-nine compartments. It is to be understood, however, that other embodiments may include a greater or fewer number of compartments depending on the requirements of the installation. In various embodiments, one or more of the compartments may include electrical receptacles for charging laptops and/or other mobile products.

The cabinet 100 also includes an electrical box assembly 114 containing a console 115. In general, the console 115 is an interface for a user to enter codes in order to access the compartments. The console 115 may present information screens to a user through a display and include a keypad for receiving user input. In various embodiments, the codes may be displayed when entered so that errors may be avoided. In various embodiments, the codes may be masked as an arbitrary sequence of characters to prevent unauthorized viewing.

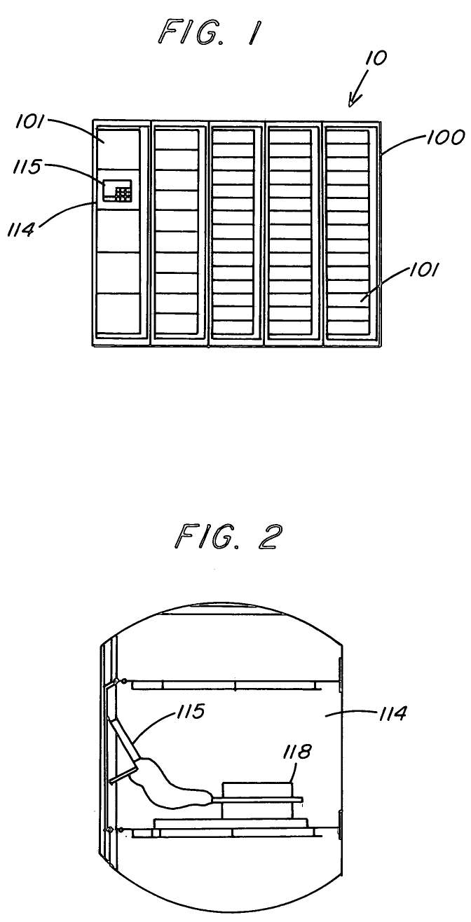

FIG. 2 illustrates various embodiments of an electrical box assembly 114. As shown, the console 115 is connected to a control unit 118. In general, the control unit 118 includes a computer system having hardware and/or software components for operating the cabinet 100. One example of a control unit 118 is a general-purpose computer capable of responding to and executing instructions in a defined manner. Other examples include a special-purpose computer, a personal computer (PC), a server, a web-enabled device, a microprocessor, an integrated circuit, or any other component, machine, tool, equipment, or some combination thereof capable of responding to and executing instructions.

The control unit 118 may function according to a program. In various embodiments, the program may include or form part of a software application (e.g., operating system, browser application, client application, server application, proxy application, on-line service provider application, and/or private network application). The program may include any type of code and/or instruction set for commanding the control unit 118 to interact and operate. The program may be implemented utilizing any suitable computer language (e.g., Java, Perl, C or C++) and/or object-oriented techniques. The program also may be a device, such as a workstation or PC, a microprocessor, a network server, a Java virtual machine, or an application-specific integrated circuit. The program may be embodied permanently or temporarily in any type of machine, component, physical or virtual equipment, storage medium, or propagated signal capable of delivering instructions.

In various embodiments, the control unit 118 receives input data from the keypad of the console 115. The control unit 118 may decode the keystrokes input by a user and provide signals to circuitry associated with the compartments for unlocking the compartments and/or for performing management operations. In various embodiments, the signals are provided to the circuitry associated with a column of compartments lockers along a common conductor.

The control unit 118 also may operate a buzzer for indicating that a compartment has been opened and may provide an audit trail printout of relevant information such as the date, time and identity number of accessed compartments, and changes of code assignments, when applicable. In various embodiments, the audit trail is accessible only to authorized personnel such as employees of the facility where the system 10 is resident, and technicians. In various embodiments, the control unit 118 includes a clock chip device for providing the date and time data for the audit trail and includes bus lines connected to a printer for producing the audit trail.

In various embodiments, the control unit 118 may be configured to communicate with a network and/or a host system associated with the facility where the system 10 is located, for example. The control unit 118 and host system may be structured and arranged to communicate using various communication protocols (e.g., HTTP, TCP/IP, WAP, UDP) to establish connections between network elements and/or to operate within or in concert with one or more other systems (e.g., the Internet and/or Web).

The network may include one or more delivery systems. Examples of delivery systems include, but are not limited to, a local area network (LAN), a wide area network (WAN), the Internet, the Web, a telephony network (e.g., analog, digital, wired, wireless, PSTN, ISDN, or xDSL), a radio network, a television network, a cable network, a satellite network, and/or any other wired or wireless communications network configured to carry data. Each network may include one or more elements, such as, for example, intermediate nodes, proxy servers, firewalls, routers, switches, adapters, sockets, and wired or wireless data pathways, configured to direct and/or deliver data.

As described above, in various embodiments, the locker system 10 is designed as a cabinet 100. Alternatively, the locker system may include one or more front-loading cabinets. In general, the cabinets may or may not include a pedestal allowing for direct placement on the floor or ground. The cabinets may have a slim design with a variety of compartment sizes. In various embodiments, the cabinets can be built into a wall, which allows for a sleek space-saving design.

In various embodiments, the locker system 10 may be a “through-the-wall” system in which a wall is formed by a bank of compartments or lockers. For example, doors may be provided on a front (access) side of the wall through which patrons may access the individual compartments. Doors also may be provided on a back (secure) side the wall for access by facility personnel. Loading may be from the front or from the back, while access by a patron to a particular compartment is achieved only from the front. An exemplary “through-the-wall” system is described in U.S. Pat. No. 4,698,630 assigned to American Locker Group Incorporated, which is incorporated by reference in its entirety.

The locker system 10 can be placed virtually anywhere such as a corridor or vestibule including those areas where a patron can have after-hours access to the locker system 10. In various embodiments, the locker system 10 may be designed as a “drive through” system allowing a user to access the locker system 10 while remaining in a vehicle.

In various embodiments, access to the compartments of the locker system 10 is achieved electronically, under the direction of a control unit 118 and circuitry associated with the compartments. In general, the locker system may operate in a normal mode and/or in a management mode. In the normal mode, a patron seeking to access a particular compartment provides a multiple digit code particularly assigned to that locker compartment. In the management mode, a person (e.g., a facility employee) provides a manager code which allows a number of separate management operations to be performed, such as assignment of a different code to a particular locker compartment, and direct access to any locker compartment using its identity number and/or its assigned code.

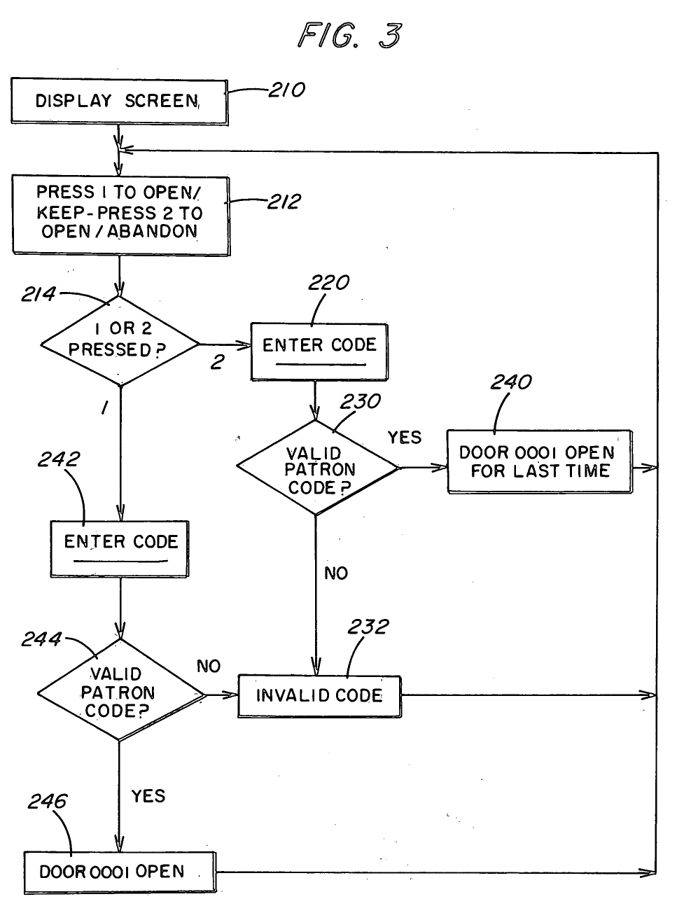

Referring to FIG. 3, the locker system 10 operates according to a normal mode procedure to provide access to a particular compartment. At step 210, the locker system 10 includes a console 115 that displays an opening screen to the patron. At step 212, the patron is presented a screen in which the patron is prompted to press a key on the keypad. For example, the patron is prompted to enter a “1” to open and keep a compartment or enter a “2” to open and abandon a compartment. At step 214 it is determined if a “1” or a “2” was pressed.

If the patron pressed a “2” (i.e., the patron is retrieving articles already stored in a compartment and the patron is abandoning the compartment after retrieval of the articles), at step 220 the patron is prompted for a code (i.e., a patron code). In various embodiments, the patron inputs the code using a keypad on the console 115. In various embodiments the patron may enter the code using a magnetic swipe card, an RFID tag, a biosensor scan, a smart card, etc. The keypad may include alphanumeric keys as well as a “clear” key for correcting incorrect keystrokes and an “enter” key for submitting the code. In various embodiments, the code is a seven-digit code. As each key is depressed, the symbol associated with the key is decoded and stored until seven data inputs for the code are successively stored. The code may be displayed to the patron for confirmation. After entering the last (e.g., seventh) digit of the code, the patron depresses the “enter” key and the code is submitted. If the patron waits too long (e.g., delays more than 10 seconds), the procedure returns to step 220 and the patron is prompted to enter a code.

If it is determined at step 230 that the code is invalid, an error message is displayed at step 232. In various embodiments, the console 115 displays an error screen to the patron. The error screen may include an error message informing the patron that the entered code is incorrect and/or expired and requesting the patron to try again. After a delay (e.g., 8 seconds), the procedure returns to step 220 and the patron is prompted to enter a code.

At step 240, if the code is valid, an appropriate door is opened for the last time using the entered code and an open door message is displayed. In various embodiments, a comparison is made between the input code and identity data associated with each compartment. For example, a locker counter and a locker pointer may be used for the purpose of comparing data for the input code with identity data stored in various memory locations corresponding to particular compartments. When a comparison indicates that the data does not match, the locker pointer is incremented by one and if the locker pointer has not achieved a maximum count, another comparison is performed. When a comparison indicates that the data for the input code matches data stored in the memory location indicated by the locker pointer, the door associated with the locker pointer is opened. The locker number of the opened door, as well as the date and time may be recorded to create an audit trail.

In addition, the console 115 displays an open door screen to the patron. The open door screen may include an open door message informing the patron that the code is valid and the door will be open for a limited time (e.g., 2 minutes). If the patron does not access within the limited time, the patron will not be able to get in, and the procedure returns to step 212.

If the patron pressed a “1” as determined at step 214 (i.e., the patron desires to reserve a compartment and store one or more articles in the compartment), at step 242 the patron is prompted for a code. In various embodiments, the patron inputs the code using a keypad on the console 115. In various embodiments the patron may enter the code using a magnetic swipe card, an RFID tag, a biosensor scan, a smart card, etc. The keypad may include alphanumeric keys as well as a “clear” key for correcting incorrect keystrokes and an “enter” key for submitting the code. In various embodiments, the code is a seven-digit code. As each key is depressed, the symbol associated with the key is decoded and stored until seven data inputs for the code are successively stored. The code may be displayed to the patron for confirmation. After entering the last (e.g., seventh) digit of the code, the patron depresses the “enter” key and the code is submitted. If the patron waits too long (e.g., delays more than 10 seconds), the procedure returns to step 242 and the patron is prompted to enter a code.

If it is determined at step 244 that the code is invalid, an error message is displayed at step 232. In various embodiments, the console 115 displays an error screen to the patron. The error screen may include an error message informing the patron that the entered code is incorrect and/or expired and requesting the patron to try again. After a delay (e.g., 8 seconds), the procedure returns to step 242 and the patron is prompted to enter a code.

At step 246, if the code is valid, an appropriate door is opened using the entered code and an open door message is displayed. In various embodiments, the next available compartment (i.e., the next compartment in a sequence of compartments that has not been assigned) is assigned to the patron. In addition to recording the code, the locker number of the opened door corresponding to the assigned compartment, as well as the date and time may be recorded to create an audit trail.

In addition, the console 115 displays an open door screen to the patron. The open door screen may include an open door message informing the patron that the code is valid and the door will be open for a limited time (e.g., 2 minutes). If the patron does not access within the limited time, the patron will not be able to get in, and the procedure returns to step 212.

In various embodiments, the code may be a patron-supplied code. Such a code may be picked arbitrarily prior to the patron entering the code for the first time at step 242. In various embodiments, the code may any length, with a maximum and minimum length, so that the patron may select a code that is meaningful to the patron. In various embodiments, the system 10 permits patrons to select a code from a predefined set of codes. In such an embodiment, the predefined codes may be stored in a storage medium in the system 10 or in a storage medium that is in communication with the system 10 or a computer that is in communication with the system 10. An example of the use of predefined codes is when the system 10 is located in a university. The set of predefined codes in such an implementation may be, for example, a set of student ID numbers, and a patron must use his or her student ID number as a code when using the system 10.

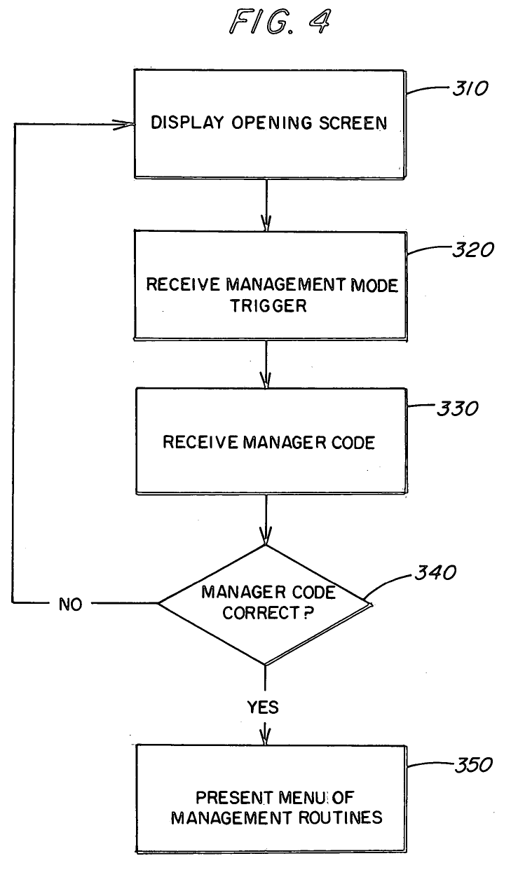

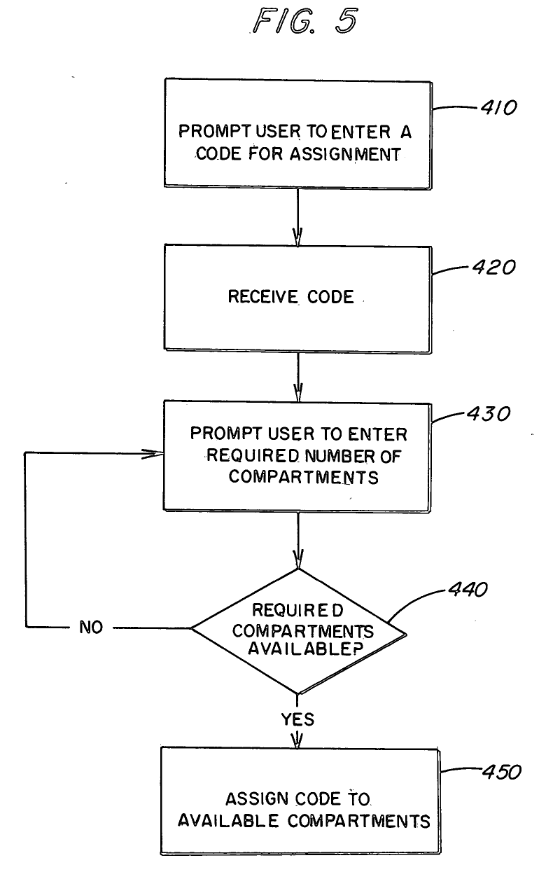

Referring to FIG. 4, the locker system 10 operates according to a management mode procedure to branch from the normal operation to one or more management routines.

At step 310, an opening screen is displayed. In various embodiments, a console 115 displays an opening screen when awaiting user input. As described above, the opening screen may include a request to enter a code.

At step 320, a management mode trigger is received. In various embodiments, a user (e.g., facility employee, technician) enters a management mode trigger instead of a code. The trigger may be a sequence of keystrokes known only by authorized users. In various embodiments, the trigger is an uninterrupted sequence of three keystrokes (e.g., <C>, <A>, <B>) that when entered displays a management mode screen.

At step 330, a manager code is received. In various embodiments, the console 115 displays a management mode screen to an authorized user. The management mode screen may request entry of a manager code associated with the authorized user. The management mode screen also may display the date and time to create a challenge code, in the event that the manager code is entered incorrectly or is forgotten.

In various embodiments, the manager code is an eight-digit code. As each key on the keypad is depressed, the symbol associated with the key is decoded and stored until eight data inputs for the manager code are successively stored. The manager code may not be displayed for added security. After entering the last (e.g., eighth) digit of the manager code, the user depresses the “enter” key and the manager code is submitted.

At step 340, it is determined whether the manager code is correct. If the manager code is incorrect, the procedure 30 returns to step 310 and the opening screen is displayed. If, on the other hand, the manager code is correct, the procedure 30 advances to step 350, and a menu of management routines is presented. In various embodiments, the menu has seven options including: 1) assign locker(s), 2) list current codes, 3) open door(s), 4) set clock, 5) set base locker, 6) set manager codes, and 7) quit. The user may select a desired option by depressing the key corresponding to the management routine.

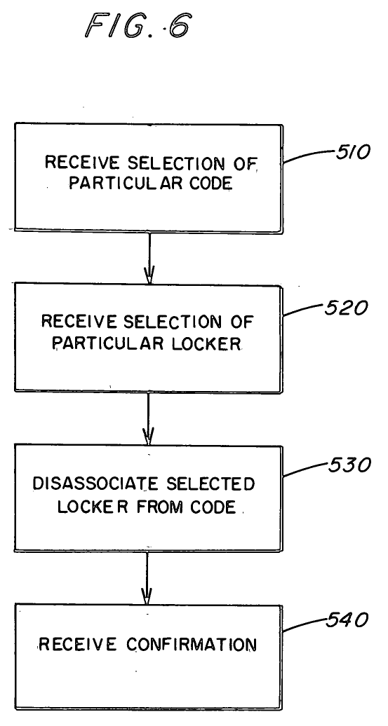

Referring to FIG. 5, a management routine is performed for assigning lockers of the locker system 10. In general, this management routine is performed after a correct manager code is received and the corresponding menu option is selected.

At step 410, a user (e.g., facility employee, technician) is prompted to enter a code for assignment to one or more compartments. In various embodiments, the locker system 10 includes a console 115 that displays an assignment screen. The assignment screen may include a request to enter a code to assign to a compartment.

At step 420, the code is received. The user may input the code using a keypad on the console 115. The keypad may include alphanumeric keys as well as a “clear” key and an “enter” key for submitting the code. In various embodiments, depressing the “clear” key returns the user to the main menu.

At step 430, the user is prompted to enter the required number of compartments. In various embodiments, depressing the “enter” key sets the number at the default value of one. Otherwise, the user may specify multiple compartments in a single operation. Depressing the “clear” key may return the user to the previous screen.

At step 440, it is determined whether the required compartments are available. In various embodiments, if there are not enough available compartments, the amount available will be displayed. If the “enter” key is depressed, the procedure 40 returns to step 430 and the user may specify a different number of required compartments.

At step 450, the code is assigned to the available compartments. In various embodiments, the assigned compartments are displayed to the user and the door for each assigned compartment is opened. In various embodiments, the user may insert articles into the assigned compartments. Subsequently, a patron may pick up the deposited articles by accessing the assigned compartment using the code. In other cases, the user may leave the compartment empty in anticipation of returned articles from the patron associated with the code.

Referring to FIG. 6, a management routine 50 is performed for listing and/or removing currently entered codes. In general, this management routine 50 is performed after a correct manager code is received and the corresponding menu option is selected.

At step 510, a selection of a particular code is received. In various embodiments, a code and a list of the lockers associated with the code are displayed to a user (e.g., facility employee, technician). The user may select the currently displayed code and/or scroll to another code and then make a selection.

At step 520, a selection of a particular locker is received. In various embodiments, after a code has been selected, a list of all the lockers associated with the code is displayed. The user may select the first locker associated with the code and/or scroll to another associated locker and then make a selection.

At step 530, a selected locker is disassociated from the code. In various embodiments, after a particular locker has been selected, the user may delete the locker from the list of lockers associated with the code. For example, depressing the <.> key may trigger deletion of a selected locker and depressing the “clear” key may cancel a current selection.

At step 540, confirmation is received. In various embodiments, the user is requested to confirm that the particular locker is to be deleted from the list. For example, depressing the “enter” key may confirm deletion and depressing the “clear” key may cancel deletion.

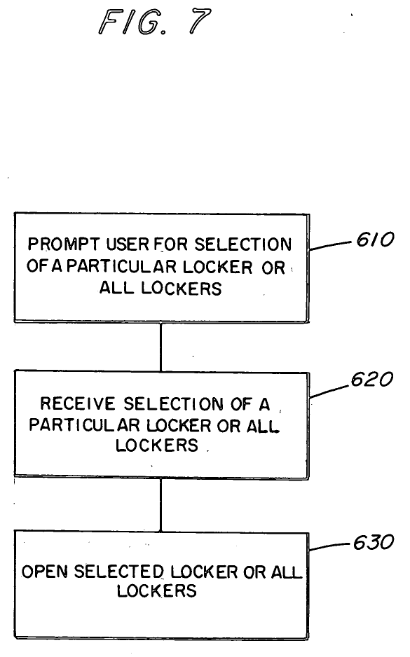

Referring to FIG. 7, a management routine 60 is performed for opening one or more doors of the locker system 10. In general, this management routine 60 is performed after a correct manager code is received and the corresponding menu option is selected.

At step 610, a prompt for a selection of a particular locker or all lockers is presented. In various embodiments, a user (e.g., facility employee, technician) is requested to enter a particular locker number to open and/or to select to open all the lockers.

At step 620, a selection of a particular locker or a selection of all lockers is received. In various embodiments, a particular locker may be selected by entering the locker number (e.g., “1”, “2”, etc.). Depressing the <0> key and then the “enter” key may select to open all of the lockers. Depressing the “clear” key may exit to the main menu.

At step 630, the selected locker or all lockers are opened. In various embodiments, the entered locker number is displayed and the locker corresponding to the entered locker number is opened. In other cases, a message that all lockers are open is displayed and all the lockers are opened.

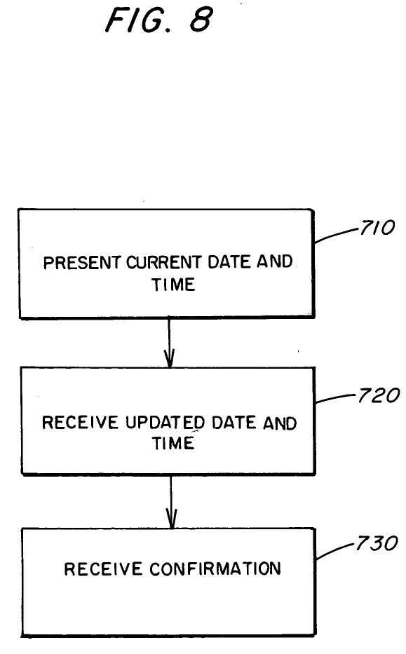

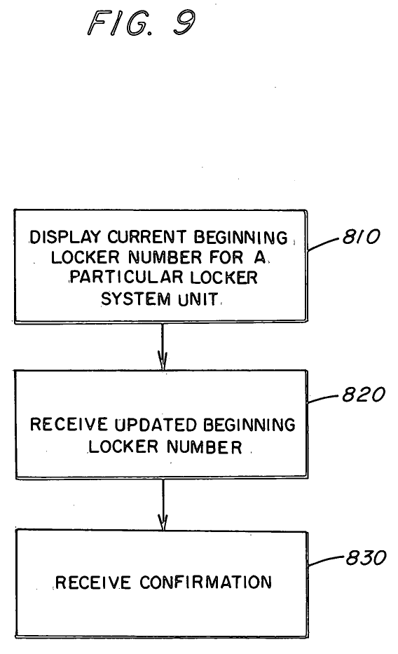

Referring to FIG. 8, a management routine 70 is performed for setting the system time. In general, this management routine 70 is performed after a correct manager code is received and the corresponding menu option is selected.

At step 710, the current date and time are presented. In various embodiments, the current date (i.e., yyyy/mm/dd) and time (i.e., hour:minute:second) are displayed to a user such as a employee or a technician.

At step 720, an updated date and time are received. In various embodiments, depressing the “enter” key advances the cursor one position and typing a number from 0-9 replaces the currently displayed number. Depressing the “clear” key may exit to the main menu.

At step 730, confirmation is received. In various embodiments, after the user scrolls through each numeric entry, the user is prompted to save the result. If the <9> key is selected at this point, the date and time will be checked for correctness and the date and time will be saved to the internal clock. Depressing the “clear” key cancels the save and allows the user to reenter the date and time.

Referring to FIG. 9, a management routine 80 is performed for setting the base locker number. In general, this management routine 80 is performed after a correct manager code is received and the corresponding menu option is selected.

At step 810, the current beginning locker number for a particular locker system unit is displayed. In various embodiments, the base locker address is set by default to 01. When multiple units are used side-by-side, for example, the locker numbers for the units other than the first unit may be remapped so that each locker will have its own locker number. Depressing the “enter” key indicates that a change is to be made. Depressing the “clear” key exits to the main menu.

At step 820, an updated beginning locker number is received. In various embodiments, an empty two-digit field is displayed. To update the beginning locker number, a user enters a number into the field. Depressing the “clear” key may exit to previous screen.

At step 830, confirmation is received. In various embodiments, after the user enters an updated beginning locker number, the user is prompted to save the result. If the “enter” key is selected, the updated beginning locker number is saved. Depressing the “clear” key cancels the save and returns to step 810.

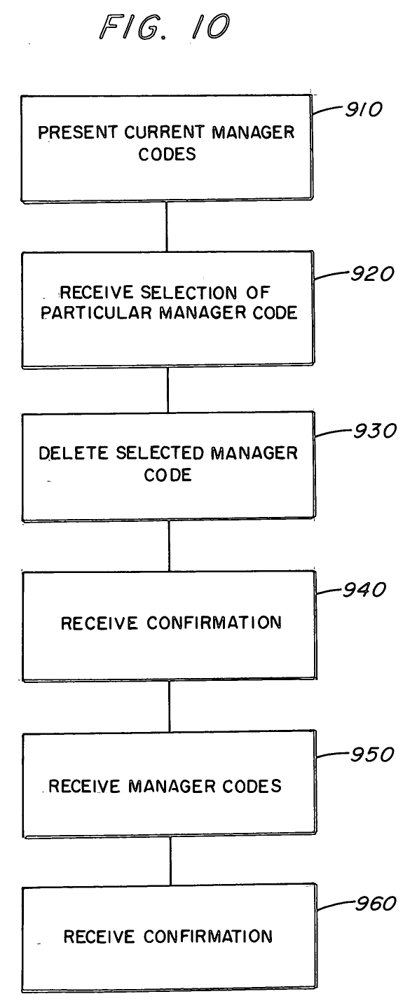

Referring to FIG. 10, a management routine 90 is performed for setting manager codes. In general, this management routine 90 is performed after a correct manager code is received and the corresponding menu option is selected.

At step 910, current manager codes are presented. In various embodiments, manager codes must be entered for a new locker system. For an existing locker system, a list of the current manager codes is displayed to a user (e.g., facility employee, technician).

At step 920, a selection of a particular manager code is received. In various embodiments, the user may select a currently displayed manager code and/or scroll to another manager code and then make a selection.

At step 930, a selected manager code is deleted. In various embodiments, after a particular manager code has been selected, the user may delete the manager code. For example, depressing the <.> key may trigger deletion of the selected manager code and depressing the “clear” key may cancel a current selection.

At step 940, confirmation is received. In various embodiments, the user is requested to confirm that the particular manager code is to be deleted from the list. For example, depressing the “enter” key may confirm deletion and depressing the “clear” key may cancel deletion.

At step 950, manager codes are received. In various embodiments, a user may enter new and/or additional manager codes. In another implementation, new or additional manager codes may be generated automatically by a random number generator, for example.

At step 960, confirmation is received. In various embodiments, after new or additional manager codes are received, the user is prompted to save the result. If the “enter” key is selected, the manager code is saved. Depressing the “clear” key cancels the save.

In view of the functionality (e.g., normal mode and/or management routines) described above, the locker system 10 may be used to secure articles for pick-up by a patron and/or to secure materials returned by a patron. In general, the locker system 10 is fully automated allowing for pick-up or drop-off at all hours. A computerized audit trail confirms pick-up, drop-off, and unauthorized attempts for full management control. In this way, each and every transaction is recorded and tracked through the audit trail stored in the locker system 10 or through standard practices.

A number of examples and embodiments have been described. Nevertheless, it will be understood that various modifications may be made and that other implementations are within the scope of the following claims.

The term “computer-readable medium” as used herein may include, for example, magnetic and optical memory devices such as diskettes, compact discs of both read-only and writeable varieties, digital versatile discs (DVDs), optical disk drives, and hard disk drives. A computer-readable medium may also include memory storage that can be physical, virtual, permanent, temporary, semi-permanent and/or semi-temporary. A computer-readable medium may further include one or more data signals transmitted on one or more carrier waves.

What is claimed is:

1. A method for securing materials in a normally locked compartment of a locker unit, the method comprising:
associating an access code with the compartment;
opening a door of the compartment upon entry of the access code by a patron; and
dissociating the access code with the compartment when the patron desires to relinquish the compartment.

2. The method of claim 1, further comprising selecting, by the patron, the access code.

3. The method of claim 1, further comprising selecting, by the patron, the access code from a predefined set of access codes.

4. The method of claim 1, further comprising determining whether the access code is valid.

5. The method of claim 4, further comprising displaying a message to the patron when the access code is not valid.

6. The method of claim 1, further comprising displaying a message to the patron when the access code is dissociated with the compartment.

7. A locker system, comprising:
a plurality of compartments, each compartment having a door in a normally locked position; and
an electrical box assembly having a computer, the computer configured to:
associate an access code with the compartment;
effectuate the opening of a door of the compartment upon entry of the access code by a patron; and
dissociate the access code with the compartment when the patron desires to relinquish the compartment.

8. The system of claim 7, wherein the computer is further configured to permit the patron to specify the access code.

9. The system of claim 7, wherein the computer is further configured to permit the patron to select the access code from a predefined set of access codes.

10. The system of claim 7, wherein the computer is further configured to determine whether the access code is valid.

11. The system of claim 10, wherein the computer is further configured to display a message to the patron when the access code is not valid.

12. The system of claim 7, wherein the computer is further configured to display a message to the patron when the access code is dissociated with the compartment.

13. An apparatus, comprising:
means for associating an access code with a normally locked compartment of a locker unit;
means for opening a door of the compartment upon entry of the access code by a patron; and
means for dissociating the access code with the compartment when the patron desires to relinquish the compartment.

14. The apparatus of claim 13, further comprising means for permitting selection, by the patron, of the access code.

15. The apparatus of claim 13, further comprising means for permitting selection, by the patron, of the access code from a predefined set of access codes.

16. A computer readable medium having stored thereon instructions which, when executed by a processor, cause the processor to:
associate an access code with a normally locked compartment of a locker unit;
effect a door of the compartment to be opened upon entry of the access code by a patron; and
dissociate the access code with the compartment when the patron desires to relinquish the compartment.

17. The medium of claim 16, further comprising instructions which, when executed by the processor, cause the processor to permit selection, by the patron, of the access code.

18. The medium of claim 16, further comprising instructions which, when executed by the processor, cause the processor to permit selection, by the patron, of the access code from a predefined set of access codes.
